(19) United States
(12) Patent Application Publication
(10) Pub. No.: US 2009/0266331 A1
(43) Pub. Date: Oct. 29, 2009

(54) PISTON FOR INTERNAL COMBUSTION ENGINE AND PROCESS FOR MANUFACTURING THE SAME

(76) Inventor: Kimihiko ANDO, Toyota-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/428,532

(22) Filed: Apr. 23, 2009

(30) Foreign Application Priority Data
Apr. 24, 2008 (JP) 2008-114591

(51) Int. Cl. F02F 3/00; B23P 15/10

(52) U.S. Cl. 123/193.6; 29/888.04

(57) ABSTRACT

A piston for internal combustion engine includes a piston body, and a low thermal conductor. The piston body has a top that faces a combustion chamber of the internal combustion engine. The low thermal conductor is disposed in the top of the piston body. Moreover, the low thermal conductor has a superficial portion, and an interior portion. The superficial portion faces the combustion chamber. The interior portion is disposed on a more inner side in the low thermal conductor than the superficial portion is. In addition, the superficial portion exhibits a first porosity. The interior portion exhibits a second porosity. The first porosity is smaller than the second porosity. Moreover, the low thermal conductor's superficial portion has a combustion-chamber-side surface that faces the combustion chamber and is subjected to shot peening.

### INCORPORATION BY REFERENCE

The present invention is based on Japanese Patent Application No. 2008-114,591, filed on Apr. 24, 2008, the entire contents of which are incorporated herein by reference.

### BACKGROUND OF THE INVENTION

1. Field of the Invention

The present invention relates to a piston for internal combustion engine, and a process for manufacturing the same.

2. Description of the Related Art

In the field of pistons for internal combustion engines, such as diesel engines and gasoline engines, it has been known to dispose a low thermal conductor in the top surface of a piston with which injected fuels collide. The low thermal conductor inhibits the thermal conduction from the sections in the piston's top surface which collide with the injected fuels, to the body of the piston. Thus, the low thermal conductor prevents unburned hydrocarbons and soot from generating at the time of cold driving, like at the time of starting the internal combustion engines. For example, Japanese Unexamined Patent Publication (KOKAI) Gazette No. 2007-315,240 discloses to use a sintered material, such as an Fe—Mn—C alloy, as the low thermal conductor, thereby keeping down the thermal conductivity low at the top of piston and approximating the thermal expansion characteristic of the piston's top to that of aluminum alloy, the piston's base material.

However, since the above-described piston's low thermal conductor is made of a sintered body, it has many pores that exit in the surfaces. Accordingly, the injected fuels soak into piston through a large of the pores of the low thermal conductor that open in the piston's combustion-chamber-side surface facing a combustion chamber of internal combustion engine. As a result, the injected fuels have become less likely mix with air. The fuels that have soaked into the piston through the pores in the combustion-chamber-side surface might be hardly combusted, and might then be discharged as they are to the outside through the combustion chamber. Consequently, there have been fears that such a piston might result in augmenting the amount of fuel emission and in degrading the fuel consumption.

Moreover, when lowering the density of low thermal conductor in order to lower the thermal conductivity of the low thermal conductor, the pores that are present in the surfaces of the low thermal conductor have increased all the more. Therefore, the amount of soaked-in fuels has increased as well.

### SUMMARY OF THE INVENTION

The present invention has been developed in view of such circumstances. It is therefore an object of the present invention to provide a piston for internal combustion engine, piston which makes it possible to inhibit fuels from soaking into it at the top that faces a combustion chamber of the internal combustion engine, and a process for manufacturing the same.

A piston for internal combustion engine according to the present invention comprises:

a piston body having a top facing a combustion chamber of the internal combustion engine; and

a low thermal conductor being disposed in the top of the piston body;

the low thermal conductor having a superficial portion facing the combustion chamber, and an interior portion being disposed on a more inner side in the low thermal conductor than the superficial portion is;

the superficial portion exhibiting a first porosity;

the interior portion exhibiting a second porosity; and

the first porosity being smaller than the second porosity.

A process for manufacturing piston for internal combustion engine, piston which comprises: a piston body having a top facing a combustion chamber of the internal combustion engine; and a low thermal conductor being disposed in the top of the piston body, and having a combustion-chamber-side surface to be disposed so as to face the combustion chamber; the manufacturing process comprises a step of:

carrying out shot peening onto the combustion-chamber-side surface of the low thermal conductor.

A piston for internal combustion engine according to the present invention comprises a low thermal conductor. The low thermal conductor comprises a superficial portion, and an interior portion. The superficial portion faces a combustion chamber of the internal combustion chamber. The interior portion is disposed on a more inner side in the low thermal conductor than the superficial portion is. Moreover, the superficial portion exhibits a first porosity, and the interior portion exhibits a second porosity. In addition, the first porosity is smaller than the second porosity. Accordingly, the present piston has a lesser quantity of pores that open in the combustion-chamber-side surface, thereby making it possible to inhibit injected fuels from soaking into the piston body. That is, the injected fuels are kept from soaking into the present piston in a large amount, and are mixed well and then combusted with air. Consequently, the present piston makes it possible to suppress or control the emission of fuels, and thereby leads to upgrading the fuel consumption of the internal combustion engine.

A process for manufacturing piston for internal combustion engine according to the present invention comprises a step of carrying out shot peening. Therefore, the present manufacturing process makes it possible to seal the pores that open in the combustion-chamber-side surface of resulting pistons. Thus, the present manufacturing process enables manufacturers to manufacture pistons into which injected fuels soak in a lesser amount.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is a cross-sectional photograph for showing a metallic structure of Test Sample No. 1 that is directed to a piston for internal combustion engine according to the present invention.

FIG. 2 is a cross-sectional photograph for showing a metallic structure of Test Sample No. 2 that is directed to a piston for internal combustion engine according to the present invention.

FIG. 3 is cross-sectional diagram for illustrating the top of a piston for internal combustion engine according to the present invention.

FIG. 4 is an explanatory cross-sectional diagram for illustrating how to carry out ultrasonic shot peening onto the top of the present piston according to Example No. 1.

FIG. 5 is a cross-sectional diagram for illustrating a low thermal conductor that makes the present piston according to Example No. 1.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

A piston for internal combustion engine according to the present invention comprises a piston body, and a low thermal conductor. The low thermal conductor is disposed in the piston's top that faces a combustion chamber of the internal combustion engine. The low thermal conductor has a combustion-chamber-side superficial portion, and an interior portion. The combustion-chamber-side superficial portion faces the combustion chamber, and exhibits a first porosity. The interior portion is disposed on a more inner side in the low thermal conductor than the combustion-chamber-side superficial portion is, and exhibits a second porosity. The first porosity is smaller than the second porosity. Specifically, the first porosity can preferably be smaller than the second porosity by a factor of from 0.05 to 0.5, more preferably from 0.1 to 0.2, for instance. The “low thermal conductor's combustion-chamber-side superficial portion that faces the combustion chamber” refers to a part of the low thermal conductor, part which extends from the combustion-chamber-side surface by a predetermined thickness. The “predetermined thickness” herein refers to a thickness of part in which compression strain arises when the low thermal conductor's combustion-chamber-side surface is subjected to shot peening. For example, the predetermined thickness can be a thickness of 50 μm m, more preferably from 30 to 50 μm, much more preferably from 40 to 50 μm. The “low thermal conductor's interior portion that is disposed on a more inner side in the low thermal conductor than the combustion-chamber-side superficial portion is” refers to a part of the low thermal conductor, part which is other than the combustion-chamber-side superficial portion and which is located on a more inner side in the low thermal conductor than the combustion-chamber-side superficial portion is located. In other words, the low thermal conductor comprises a combustion-chamber-side superficial portion, and an interior portion.

The “combustion-chamber-side superficial portion's first porosity” refers to a proportion (%) of a summed cross-sectional area of a plurality of pores that exist in the combustion-chamber-side superficial portion with respect to a cross-sectional area of the low thermal conductor's combustion-chamber-side superficial portion, cross-sectional area which the outside dimensions determine. Likewise, the “interior portion's second porosity” refers to a proportion (%) of a summed cross-sectional area of a plurality of pores that exist in the interior portion with respect to a cross-sectional area of the low thermal conductor's interior portion, cross-sectional area which the outside dimensions determine. Note herein that the “pores” mean both of the following: not only the open pores that communicate with the outside of the low thermal conductor but also the closed pores that do not communicate with the outside. It is possible to measure the combustion-chamber-side superficial portion's first porosity, and the interior portion's second porosity by means of image analysis as described below, for instance. That is, a cross-sectional photograph of the low thermal conductor is taken on plural fields of view with a predetermined magnification. Then, a summed area of a large number of pores that are present in the low thermal conductor's combustion-chamber-side superficial portion, and a summed area of a large number of pores that are present in the interior portion are found by means of image analysis for each of the photographed fields of view. The thus obtained summed areas of the pores that exist in the combustion-chamber-side superficial portion, and the thus obtained summed areas of the pores that exist in the interior portion are then summed up, respectively. Meanwhile, a summed area of the low thermal conductor's combustion-chamber-side superficial portion, and a summed area of the interior portion are found by means of image analysis for each of the photographed fields of view, and are then summed up similarly for each of the combustion-chamber-side superficial portion and the interior portion. Finally, the summed-up area of the pores that are present in the combustion-chamber-side superficial portion, and the summed-up area of the pores that are present in the interior portion are divided by the summed-up area of the combustion-chamber-side superficial portion and the summed-up area of the interior portion, respectively, and are then converted into their percentages, thereby determining the combustion-chamber-side superficial portion's first porosity, and the interior portion's second porosity, respectively.

The smaller the combustion-chamber-side superficial portion's first porosity is, the more preferable it is. This is because the combustion-chamber-side superficial portion with a smaller first porosity can keep the amount of fuels soaking into the combustion-chamber-side surface of the piston body down in a lesser amount. The combustion-chamber-side superficial portion can exhibit a first porosity of less than 10% by cross-sectional area, more preferably 5% or less by cross-sectional area, much more preferably from 0 to 2% by cross-sectional area. Note that, when the combustion-chamber-side superficial portion exhibits a first porosity that surpasses 10%, it might allow fuels to soak into the piston body's combustion-chamber-side surface.

The interior portion's second porosity can preferably fall, in a range of from 10 to 40% by cross-sectional area, more preferably from 15 to 30% by cross-sectional area. When the interior portion exhibits a second porosity of less than 10%, the resulting low thermal conductor exhibits increased thermal conductivity to inhibit the temperature in a combustion chamber of internal combustion engine from rising quickly in cold driving so that unburned hydrocarbons and soot might generate. On the other hand, when the interior portion exhibits a second porosity that exceeds 40%, the resultant low thermal conductor might exhibit degraded strength.

The superficial portion of the low thermal conductor can preferably have a combustion-chamber-side surface facing the combustion chamber, and the low thermal conductor can preferably further have open pores that open in the combustion-chamber-side surface and exhibit an open porosity of 2% by volume or less. Note that the open pores can preferably exhibit an open porosity of 1% by volume or less, much more preferably from 0 to 0.5% by volume. Moreover, the “open porosity of open pores that open in the combustion-chamber-side surface” herein refers to a proportion (%) of a summed volume of a plurality of pores, which open in the low thermal conductor's combustion-chamber-side surface and communicate with the outside, with respect to a volume of the low thermal conductor's overall configuration, and is determined in accordance with JIS Z2501, one of Japanese Industrial Standards. When the open pores exhibit an open porosity of 2% by volume or less, the open pores are present less in the low thermal conductor's combustion-chamber-side surface so that it is possible to effectively inhibit fuels that are injected onto the combustion-chamber-side surface from soaking into the low thermal conductor. On the other hand, when the open pores exhibit an open porosity that surpasses 2% by volume, the injected fuels might soak into the low thermal conductor's combustion-chamber-side surface in a greater amount to result in increasing the emission of fuels.

The low thermal conductor can preferably exhibit as a whole a porosity falling in a range of from 3 to 30% by cross-sectional area, more preferably from 10 to 30% by cross-sectional area. When the overall porosity is less than 3% by cross-sectional area, the resulting low thermal conductor might exhibit degraded thermally-conducting capability. On the contrary, when the overall porosity exceeds 30% by cross-sectional area, the resultant low thermal conductor might exhibit deteriorated strength. Note herein that the “low thermal conductor's overall porosity” refers to a proportion (%) of a summed cross-sectional area of a plurality of pores that exist in the entire low thermal conductor, cross-sectional area which the overall outside dimensions determine. Moreover, the “pores” herein mean both open pores and closed pores. The low thermal conductor's overall porosity can be measured by means of image analysis as follow. For example, a cross section of the entire low thermal conductor is photographed on multiple fields of view with a predetermined magnification. Then, a summed area of a large number of pores that are present in the entire low thermal conductor is found by means of image analysis for each of the photographed fields of view. The thus obtained summed areas of the pores that exist in the entire low thermal conductor are then summed up. Meanwhile, a summed area of the entire low thermal conductor is found by means of image analysis for each of the photographed fields of view, and the resulting summed areas are then summed up similarly. Finally, the summed-up area of the pores that are present in the entire low-thermal conductor is divided by the summed-up area of the low thermal conductor, and is then converted into its percentage, thereby determining the low thermal conductor's overall porosity.

The low thermal conductor can preferably comprise a sintered body, which exhibits thermal conductivity that is smaller than that of the piston body. It is more preferable that a sintered body can comprise an alloy that includes Fe (iron) and Mn (manganese). The thus constituted low thermal conductor enables the piston body's top to exhibit suppressed or controlled thermal conductivity. Moreover, it is possible to inhibit thermal fatigue breakage from occurring in the low thermal conductor, because the sintered body makes it possible to approximate the low thermal conductor's thermal expansion characteristic to that of aluminum alloy, the piston body's base material. Note that the alloy can preferably comprise Mn in an amount of from 10 to 50% by mass, C in an amount of from 0.5 to 1.5% by mass, Ni in an amount of from 0 to 5% by mass, Cr in an amount of from 0 to 1% by mass, Ti in an amount of from 0 to 0.5% by mass, and the balance of inevitable impurities, when the entirety is taken as 100% by mass.

In order to manufacture the piston for internal combustion engine according to the present invention, the low thermal conductor is made first off. For example, the low thermal conductor can be made by means of a manufacturing process that comprises the following: a step of preparing a raw material; a step of molding a powder compact; and a step of sintering the resulting powder compact, for instance.

In the raw-material preparing step, raw-material powders, such as an Fe—Mn alloy powder and a graphite powder or a manganese powder, an iron powder and a graphite powder, are compounded so that they make desirable contents of the constituent elements in the low thermal conductor or sintered body, such as Mn, C and Fe, for instance, and the raw-material powders are then mixed uniformly. Each of the raw-material powders can be produced by means of atomizing, such as gas atomizing, or pulverizing, for instance. Note that the respective raw-material powders can preferably exhibit an average particle diameter of 150 μm or less.

At the molding step, the mixed raw-material powders are filled into a die, for instance, to mold them into a powder compact with desirable configuration by means of pressure forming. It is possible to control the strength and pore characteristics of the resulting powder compact within desirable ranges by adjusting the compression load for compressing the mixed raw-material powders during the pressure forming. When molding the powder compact by means of pressure forming, the compression load can preferably fall in a range of from 500 to 1,000 MPa, more preferably from 600 to 800 MPa. When the compression load is less than 500 MPa, it is less likely to produce the powder compact with sufficient strength. When the compression load is more than 1,000 MPa, the molding die might suffer from seizure.

At the sintering step, the powder compact that has been molded at the molding step is then sintered. It is allowable to sinter the powder compact at a sintering temperature of from 1,100 to 1,300° C., preferably from 1,150 to 1,250° C., for a sintering time of from 10 to 60 minutes, preferably from 20 to 60 minutes. Sintering the powder-compact at a sintering temperature of less than 1,100° C. is not preferable, because the resulting sintered body might exhibit insufficient strength. Sintering the powder compact at a sintering temperature that exceeds 1,300° C., is not preferable, because the resulting sintered body might be provided with coarse pores. In order to prevent the powder compact from being oxidized, it is allowable to sinter the powder compact in a nitrogen gas atmosphere whose nitrogen-gas partial pressure is 1 atm approximately.

The low thermal conductor that has been produced by way of the above-described steps is then disposed on the top of the piston body. For example, the low thermal conductor is put in place on the top of the piston body, and is then buried or enveloped in the top by casting with a metallic molten metal.

Subsequently, the combustion-chamber-side surface of the low thermal conductor is subjected to shot peening. The shot peening seals pores that open in the combustion-chamber-side surface. Accordingly, it is possible to make the first porosity of the superficial portion, which faces the combustion chamber of internal combustion engine, smaller than the second porosity of the interior portion, which is disposed on a more inner side in the low thermal conductor than the superficial portion is. Moreover, it is possible to make the open porosity of pores, which open in the combustion-chamber-side surface, smaller. Consequently, it is possible to effectively keep down the amount of injected fuels that soak into the low thermal conductor.

Moreover, it is preferable to control the open porosity of the open pores that open in the combustion-chamber-side surface of the low thermal conductor to 2% by volume or less, more preferably to 1% by volume or less, much more preferably in a range of from 0 to 0.5% by volume, by means of the shotpeening. Thus, it is possible to effectively inhibit fuels being injected onto the combustion-chamber-side surface from soaking into the low thermal conductor.

It is allowable to carry out the shot peening onto the combustion-chamber-side surface of the low thermal conductor after finishing disposing the low thermal conductor on the top of the piston body. That is, when processing the top of the piston body is required on the outermost layer after cast burying or enveloping the low thermal conductor in the top of the piston body, it is allowable to carry out the shot peening onto the combustion-chamber-side surface of the low thermal conductor that has been cast buried or enveloped.

It is allowable to carry out the shot peening by means of ultrasonic shot peening. The ultrasonic shot peening makes it possible to effectively seal pores that open in the combustion-chamber-side surface of the low thermal conductor even after disposing the low thermal conductor on the piston body's top.

The ultrasonic shot peening can preferably comprise the steps of: disposing the low thermal conductor on the top of the piston body; enclosing an outer periphery of the combustion-chamber-side surface of the low thermal conductor with a housing; and colliding steel balls with the combustion-chamber-side surface within the housing. Thus, it is possible to carry out shot peening onto the low thermal conductor alone that is disposed on the top of the piston body, without ever shot peening the piston body's own top, namely, the top of the piston in which the low thermal conductor does not appear.

It is preferable to carry out the shot peening under such conditions that enable the low thermal conductor to exhibit an open porosity of 2% by volume or less.

For example, suitable conditions for the shot peening can preferably be such conditions that produce the shot-peened almen strip (or datum test specimen) that shows an arc height of from 0.03 to 0.2 mm (i.e., a warped height of the almen strip after shot peening) and a coverage of from 50 to 300%, more preferably from 100 to 300%, (i.e., a proportion of the dented area to the total area of the almen strip after shot peening). Note that the almen strip herein refers to a datum test specimen whose width is 19 mm, length is 76 mm and thickness is 1.3 mm, and which exhibits a hardness of from 46 to 50 H_{R}C. When the shot peening is carried out under such conditions that result in the shot-peened almen strip that shows an arc height of less than 0.03 mm and a coverage of less than 50%, the resultant low thermal conductor's superficial portion exhibits such an increased first porosity that injected fuels might likely to soak into the piston body through the combustion-chamber-side surface. When the shot peening is carried out under such conditions that produce the shot-peened almen strip that shows an arc height of more than 0.2 mm and a coverage of less than 300%, no advantages meeting the shot-peening conditions can be expected.

In addition to the ultrasonic shot peening as described above, it is allowable to carry out the shot peening by means of air-blasting shot peening or impeller-blasting shot peening, for instance.

Note that it is allowable to carry out the shot peening after disposing the low thermal conductor on the top of the piston body. However, when the processible allowance remains less after the disposition, it is allowable to carry out the shot peening onto the low thermal conductor itself before disposing the low thermal conductor on the top of the piston body.

### EXAMPLES

The present invention will be hereinafter described in more detail with reference to the following evaluations using test samples and pistons, and to the following examples. Test Sample Nos. 1 through 6 below relate to low thermal conductors, and their pore characteristics were examined by Evaluation No. 1. Note that Test Sample Nos. 1, 2, 4 and 6 are products according to the present invention, and Sample Nos. 3 and 5 are comparative products.

### Preparation of Sample No. 1

An alloy powder whose composition is given in Table 1 below was prepared, and was then mixed with graphite and an iron powder in a compounding ratio that is given in Table 2 below, thereby making a raw-material powder. The resulting raw-material powder was pressed by a compression load of 800 MPa to mold it into a disk-shaped powder compact whose diameter was 65 mm and thickness was 10 mm. The resultant powder compact was sintered at a sintering temperature of 1,250° C. for a sintering time of 30 minutes in a nitrogen atmosphere whose nitrogen partial pressure was 1 atm, thereby making a sintered workpiece. As set forth in Table 3 below, the thus produced sintered workpiece comprised Mn in an amount of 24.9% by mass, C in an amount of 1.0015% by mass, and the balance of Fe. Note that the raw-material powder for making low thermal conductor exhibited an average particle diameter of 150 μm or less. The thus obtained sintered workpiece was cut out into a test sample whose diameter was 50 mm and thickness was 1 mm, and was then subjected to ultrasonic shot peening. The ultrasonic shot peening was carried out by bombarding either one of the test sample's top surface or bottom surf ace with shots, namely, steel balls that were accelerated with vibrating piezoelectric element. Note that the steel balls had a particle diameter of 0.6 mm, and exhibited a hardness of 800 Hᵥ. Moreover, the piezoelectric element was vibrated with an amplitude of 90 μm. In addition, as set forth in Table 4 below, the ultrasonic shot peening was carried out under such conditions for producing the almen strip that exhibited an arc height of 0.128 mm and a coverage of 100% after the ultrasonic shot peening.

TABLE 1

| Chemical Component in Alloy Powder (% by mass) | | | | | | Production |
|---|---|---|---|---|---|---|
| Mn | Ni | Cr | C | Ti | Fe | Process |
| 50 | Not | Not | 0 | Not | Balance | Gas |
| | Applicable | Applicable | | Applicable | | Atomizing |

TABLE 2

| Compounding Ratio of Raw-material | | | |
|---|---|---|---|
| Powder (% by mass) | | | Particle Dia. |
| Alloy Powder | Graphite | Iron Powder | (μm) |
| 50 | 1 | 49 | 150 or less |

TABLE 3
Composition of Sintered Workpiece (% by mass)

| Mn | Ni | Cr | C | Ti | Fe |
|---|---|---|---|---|---|
| 24.9 | Not | Not | 1.0015 | Not | Balance |
| | Applicable | Applicable | | Applicable | |

TABLE 4

| | Compression | Conditions for Ultrasonic Shot Peening | | | | |
|---|---|---|---|---|---|---|
| Test | Load at | | | | Amplitude of | |
| Sample | Molding | Arc Height | Coverage | Dia. Of | Piezoelectric | |
| No. | (MPa) | (mm) | (%) | Shots (mm) | Element (μm) | Remarks |
| 1 | 800 | 0.128 | 100 | 0.6 | 90 | Present |
| | | | | | | Product |
| 2 | 800 | 0.044 | 100 | 0.6 | 30 | Present |
| | | | | | | Product |
| 3 | 800 | Not | Not | Not | Not | Comp. |
| | | Applicable | Applicable | Applicable | Applicable | Product |
| 4 | 1000 | 0.128 | 100 | 0.6 | 90 | Present |
| | | | | | | Product |
| 5 | 1000 | Not | Not | Not | Not | Comp. |
| | | Applicable | Applicable | Applicable | Applicable | Product |
| 6 | 800 | 0.084 | 100 | 0.6 | 50 | Present |
| | | | | | | Product |

### Preparation of Test Sample No. 2

A sintered workpiece was made in the same manner as that was made in above-described Test Sample No. 1. The resulting sintered workpiece was cut out into a test sample in the same manner as set forth in Test Sample No. 1. Then, the cut-out test sample was subjected to ultrasonic shot peening. Note that, when shot peening the resultant test sample, the piezoelectric element was vibrated with an amplitude of 30 μm. Moreover, as set forth in Table 4 above, the cut-out test sample was subjected to the ultrasonic shot peening that was carried out under such conditions that resulted in the shot-peened almen strip that exhibited an arc height of 0.044 mm and a coverage of 100%.

### Preparation of Test Sample No. 3

A sintered workpiece was made in the same manner as that was made in above-described Test Sample No. 1. The resulting sintered workpiece was cut out into a test sample in the same manner as set forth in Test Sample No. 1. However, the cut-out test sample was not subjected to ultrasonic shot peening at all.

### Preparation of Test Sample No. 4

A raw-material powder was prepared in the same manner as disclosed in above-described Test Sample No. 1. The resulting raw-material powder was pressed by a compression load of 1,000 MPa to mold it into the same disk-shaped powder compact as set forth in Test Sample No. 1. The resultant powder compact was sintered under the same sintering conditions as disclosed in Test Sample No. 1, thereby making a sintered workpiece. The thus obtained sintered workpiece was cut out into a test sample in the same manner as set forth in Test Sample No. 1. Then, the cut-out test sample was subjected to ultrasonic shot peening that was carried out under the same conditions as disclosed in Test Sample No. 1.

### Preparation of Test Sample No. 5

A sintered workpiece was made in the same manner as that was made in above-described Test Sample No. 4. The resulting sintered workpiece was cut out into a test sample in the same manner as set forth in Test Sample No. 1. However, the cut-out test sample was not subjected to ultrasonic shot peening at all.

### Preparation of Test Sample No. 6

A sintered workpiece was made in the same manner as that was made in above-described Test Sample No. 1. The resulting sintered workpiece was cut out into a test sample in the same manner as set forth in Test Sample No. 1. Then, the cut-out test sample was subjected to ultrasonic shot peening. Note that, when shot peening the resultant test sample, the piezoelectric element was vibrated with an amplitude of 50 μm. Moreover, as set forth in Table 4 above, the cut-out test sample was subjected to the ultrasonic shot peening that was carried out under such conditions that resulted in the shot-peened almen strip that exhibited an arc height of 0.084 mm and a coverage of 100%.

### Evaluation. No. 1

Test Sample Nos. 1 through 6 were examined for the first porosity of the superficial portion that extended by a thickness of 50 μm from the outermost surface, and the second porosity of the interior portion that was disposed on a more inner side therein than the superficial portion was by means of the above-disclosed image analysis. For example, a cross-sectional photograph of the test samples was taken on 10 fields of view with a magnification of ×400. Then, a summed area of a large number of pores that were present in the test samples' superficial portion was found by means of image analysis for each of the photographed 10 fields of view. Then, the thus obtained summed areas of the pores that existed in the test samples' superficial, portion were summed up. Likewise, a summed area of a large number of pores that were present in the interior portion was found by means of image analysis for each of the photographed 10 fields of view. Then, the thus obtained summed areas of the pores that existed in the test samples' interior portion were summed up similarly. Meanwhile, a summed area of the test samples' superficial portion was found by means of image analysis for each of the photographed 10 fields of view. Then, the thus obtained summed areas of the test samples' superficial portion were summed up for each of the test samples' superficial portion. Likewise, a summed area of the test samples' interior portion was found by means of image analysis for each of the photographed 10 fields of view. Then, the thus obtained summed areas of the test, samples' interior portion were summed up similarly for each of the test samples' interior portion similarly. Finally, the summed-up area of the pores that were present in the test samples' superficial portion was divided by the summed-up area of the test samples' superficial portion, and was then converted into the percentage, thereby determining the first porosity of the test samples' superficial portion, respectively. Likewise, the summed-up area of the pores that were present in the test samples' interior portion was divided by the summed-up area of the test samples' interior portion, and was then converted into the percentage, thereby determining the second porosity of the test samples' interior portion, respectively.

Moreover, the test samples were examined for the overall porosity by means of image analysis as follow. For example, a cross section of the entire test samples was photographed on 10 fields of view with a magnification of ×400, respectively. Then, a summed area of a large number of pores that were present in the entire test samples were found by means of image analysis for each of the photographed 10 fields of view. The thus obtained summed areas of the pores that existed in the entire test samples were then summed up, respectively. Meanwhile, a summed area of the entire test samples was found by means of image analysis for each of the photographed 10 fields of view. Then, the resulting summed areas were similarly summed up, respectively. Finally, the summed-up area of the pores that were present in the entire test samples was divided by the summed-up area of the test samples, and was then converted into its percentage, thereby determining the overall porosity of the test samples, respectively.

In addition, Test Sample Nos. 1, 2, 4 and 6 were examined respectively to determine the open porosity of pores that opened in one of their opposite surfaces, namely, one of the top and bottom surfaces, in accordance with JIS Z2501. Note that a pore-sealing treatment was carried out by means of nickel plating and copper plating onto the other one of the opposite surfaces, that is, the other one of the opposite surfaces that was not subjected to the ultrasonic shot peening, as well as onto the peripheral surface, before measuring the open porosity. Likewise, Test Sample Nos. 3 and 5 to which no ultrasonic shot peening was performed were examined respectively to determine the open porosity of pores that opened in one of their opposite surfaces. Note however that the open porosity was measured respectively after carrying out the pore-sealing treatment onto the other one of the opposite surfaces and onto the peripheral surface.

Moreover, disk-shaped test pieces with 5-mm diameter and 1-mm thickness were cut out from out of Test Sample Nos. 1 through 6, respectively, in order to examine the thermal conductivity. Note that the thermal conductivity that the cut-out disk-shaped test pieces exhibited was measured by means of laser flashing method that is prescribed in JIS R1611.

Table 5 below summarizes the measurement results on the first porosity of the superficial portion of Test Sample Nos. 1 through 6, the second porosity of the interior portion thereof, the overall porosity thereof, the open porosity of the one of the opposite surfaces thereof, and the thermal conductivity thereof.

TABLE 5

| | First Porosity | Second Porosity | Overall | | | |
|---|---|---|---|---|---|---|
| | of Superficial | of Interior | Porosity of Test | Open | | |
| Test | Portion (% by | Portion (% by | Sample (% by | Porosity | Thermal | |
| Sample | cross-sectional | cross-sectional | cross-sectional | (% by | Conductivity | |
| No. | area) | area) | area) | volume) | (W/(m · K)) | Remarks |
| 1 | 2 | 15 | 15 | 0.2 | 9 | Present |
| | | | | | | Product |
| 2 | 4 | 15 | 15 | 1.5 | 8 | Present |
| | | | | | | Product |
| 3 | 15 | 15 | 15 | 15 | 7.5 | Comp. |
| | | | | | | Product |
| 4 | 1 | 3 | 3 | 0.1 | 15 | Present |
| | | | | | | Product |
| 5 | 3 | 3 | 3 | 2.5 | 13 | Comp. |
| | | | | | | Product |
| 6 | 3 | 15 | 15 | 1 | 8 | Present |
| | | | | | | Product |

According to the measurement results given in Table 5 above, Test Sample Nos. 1, 2, 4 and 6, namely, the present products that underwent the ultrasonic shot peening, were found to comprise the superficial portion whose first porosity fell in a range of from 1 to 4% by cross-sectional area. Moreover the first porosities that Test Sample Nos. 1, 2, 4 and 6 exhibited were smaller than the second porosities. In addition, Test Sample Nos. 1, 2, 4 and 6 exhibited a smaller open porosity than the overall porosity. That is, the open porosity of pores that opened in the test samples' one of the opposite surfaces was smaller than the overall porosity that the test samples exhibited. In particular, Test Sample Nos. 1, 2, 4 and 6 exhibited an open porosity of 2% by volume or less. From these facts, it is apparent that Test Sample Nos. 1, 2, 4 and 6, i.e., the present products, comprised the superficial portion in which many of the pores, not only the closed pores but also the open pores, were crushed or squashed because the ultrasonic shot peening was performed onto their superficial portions.

On the contrary, Test Sample Nos. 3 and 5, namely, the comparative products that did not undergo the ultrasonic shot peening, were found to comprise the superficial portion that exhibited a first porosity being equal to the interior portion's second porosity. Moreover, Test Sample Nos. 3 and 5 exhibited an open porosity that was equal to the overall porosity of their own substantially. That is, the open porosity of the test samples was equal to the overall porosity virtually. From these facts, the following are apparent: in Test Sample Nos. 3 and 5, the superficial portion and the interior portion had pore distributions that were uniform to each other substantially; and most of the pores that were present in the test samples were open pores.

Moreover, Test Sample Nos. 1, 2, 3 and 6 that exhibited a larger overall porosity showed a lower thermal conductivity than Test Sample Nos. 4 and 5 that exhibited a smaller overall porosity did. It follows that it is apparent that the larger the overall porosity of test sample is the more possible it is to make the thermal conductivity smaller.

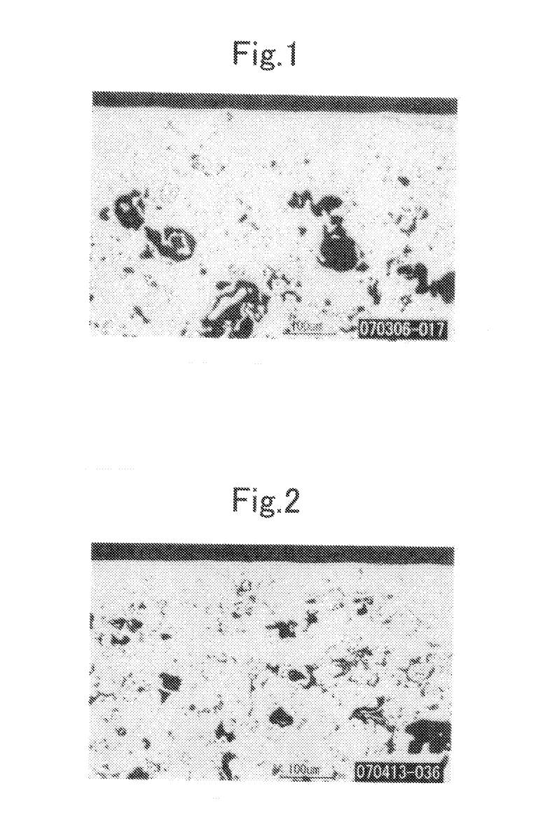

FIG. 1 shows a cross-sectional metallic structure of Test Sample No. 1. FIG. 2 shows a cross-sectional metallic structure of Test Sample No. 2. Note that FIGS. 1 and 2 are metallographic-microscope photographs that were taken with a magnification of ×100. It is seen from FIG. 1 that, in Test Sample No. 1 that underwent the ultrasonic shot peening, the superficial portion had virtually no pores from the outermost surface to the thickness of 100 μm, but the interior portion, which was on a more inner side to the superficial portion, had many remaining pores whose pore diameters were from 20 to 100 μm approximately. On the other hand, it is seen from FIG. 2 that, in Test Sample No. 2, pores were present less in the section between the outermost surface and the 50-μm thickness, and a large number of pores whose pore diameters were from 20 to 100 μm approximately were dispersed uniformly in the interior portion that lay on the inner side to the section.

### Example. No. 1

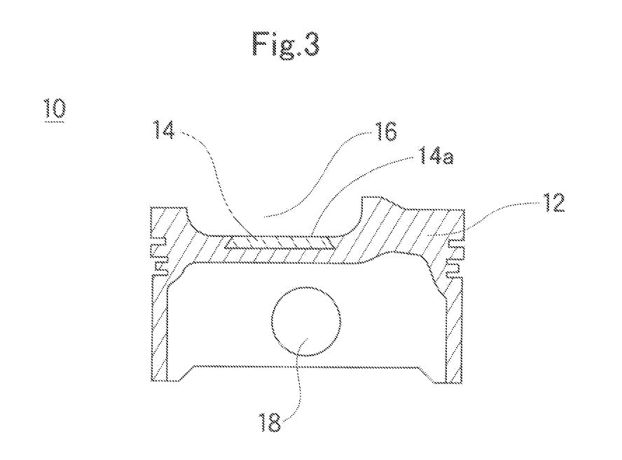

As illustrated in FIG. 3, a piston for internal combustion engine according to Example No. 1 of the present invention comprises a piston body 12, and a low thermal conductor 14. The low thermal conductor 14 is disposed on the top of the piston body 12. The piston body 12 is formed of casting that is made of an aluminum alloy, such as AC8A according to JIS, for instance (hereinafter might be referred to as “piston body 12's base material wherever appropriate). The top of the piston body 12 is provided with a dent 16. The dent 16 demarcates a combustion chamber together with a not-shown cylinder head and cylinder. An internal combustion chamber is made so as to inject fuels toward the dent 16. Note that the low thermal conductor 14 is disposed in a section of the dent 16 onto which the fuels are injected.

Since the low thermal conductor 14 exhibits thermal conductivity that is remarkably lower than that of the aluminum alloy, the combustion chamber can undergo temperature increase so efficiently that the vaporization of fuels can be facilitated. The low thermal conductor 14 is made of a sintered body that, comprises the same Fe—Mn—C alloy as that was used in Test Sample No. 1 above. That is, the composition of the sintered body is 24.9%-by-mass Mn, 1.0015%-by-mass C, and the balance of Fe and inevitable impurities, as given in Table 3 above. A raw-material powder for making the low thermal conductor 14 has an average particle diameter of 150 μm or less. Moreover, the low thermal conductor 14 has a combustion-chamber-side surface 14a that faces the combustion chamber. In addition, an ultrasonic shot-peening process has been performed onto the combustion-chamber side surface 14a.

A process for manufacturing the piston for internal combustion engine according to Example No. 1 will be hereinafter described. First of all, a sintered body according to above-described Test Sample No. 1 was made. The resulting sintered body was processed into a disk shape whose diameter was 50 mm and thickness was 1.5 mm, thereby producing a precursor of the low thermal conductor 14.

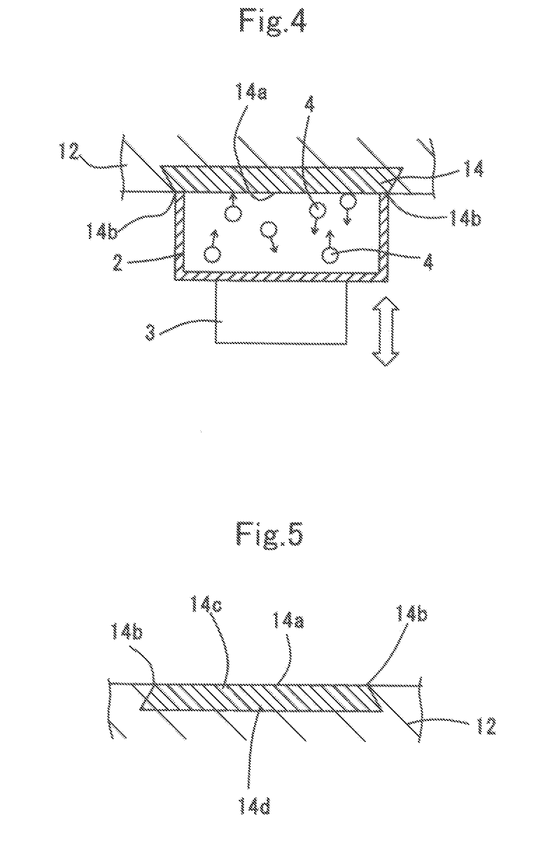

The resulting precursor of the low thermal conductor 14 was cast buried or enveloped in the top of the piston body 12 with a molten metal of AC8A aluminum alloy. Moreover, the piston body 12 with the precursory low thermal conductor 14 being disposed was processed on the top surface only by 0.5-mm outermost layer. Then, as illustrated in FIG. 4, the precursor of the low thermal conductor 14 was enclosed with a housing 2 at the outer periphery 14b. Thereafter, within the housing 2, ultrasonic shot peening was carried out onto the combustion-chamber-side surface 14a of the precursory low thermal conductor 14. Note that the ultrasonic shot peening was carried out by bombarding the combustion-chamber-side surface 14a of the precursory low thermal conductor 14 with steel balls 4 that were accelerated by means of vibrating a piezoelectric element 3. Moreover, the ultrasonic shot peening was carried out under the same conditions as those for making Test Sample No. 1 that was prepared for above-described Evaluation No. 1. Thus, the present piston according to Example No. 1 was manufactured.

As illustrated in FIG. 3, the piston body 12 was provided with the low thermal conductor 14 in the top. The low thermal conductor 14 exhibited the same pore characteristics and thermal conductivity as those exhibited by Test Sample No. 1. Accordingly, as can be understood from Table 5 above, a superficial portion 14c that made the combustion-chamber-side surface 14a of the low thermal conductor 14 shown in FIG. 5 exhibited the first porosity that was smaller than the second porosity exhibited by an interior portion 14d. Moreover, not only the superficial portion 14c exhibited the first porosity that was smaller than the overall porosity of the low thermal conductor 14, but also the low thermal conductor 14 exhibited an open porosity of 2% by volume or less. In addition, not only the present piston according to Example No. 1 comprised the low thermal conductor 14 that was put in place in the top, but also the low thermal conductor 14 was made of the sintered body that comprised the Fe—Mn—C alloy exhibiting low thermal conductivity. Consequently, the present piston according to Example No. 1 not only enabled the combustion chamber of internal combustion engine to increase the temperature higher effectively but also enabled fuels to facilitatively vaporize effectively.

### Evaluation No. 2

Subsequently, the piston according to Example No. 1 of the present invention was examined for the relationship between the open porosity, which the low thermal conductor exhibited, and the amount of fuels, which were soaked into the combustion-chamber-side surface.

In the same manner as the piston according to Example No. 1 of the present invention, a precursor of Test Sample No. 1 was cast buried or enveloped in the top of the piston body, and the precursor's exposed surface, one of the opposite surfaces turning into the combustion-chamber-side surface of the low thermal conductor, was then subjected to ultrasonic shot peening. Note that the conditions of the ultrasonic shot peening were adjusted so that the resulting low thermal conductors exhibited an open porosity of 0.2%, 1.5%, 5% and 15% by volume as recited in Table 6 below, and the resultant four pistons are labeled “A,” “B,” “C” and “D” in this order in the table.

The pistons “A” through “D” were incorporated into a direct gasoline-injection engine to assemble it. The direct gasoline-injection engine with the pistons “A” through “D” being provided was driven at an engine revolution speed of 6,000 rpm for 2 hours. After the operation, the low thermal conductors that were disposed in the top of the pistons “A” through “D” were disassembled, and were then subjected to Soxhlet extraction in order to remove oil contents from them. The low thermal conductors were weighed for their weight reductions, the reduced parts by weight that resulted from the extraction, thereby finding the amounts of fuels that soaked into the low thermal conductors. Table 6 below gives the thus determined results.

TABLE 6

| Piston | Open Porosity | Soaked Amount |
|---|---|---|
| Identification | (% by volume) | (mg) |
| “A” | 0.2 | 0.2 |
| “B” | 1.5 | 1 |
| “C” | 5 | 9 |
| “D” | 15 | 20 |

As can be appreciated from Table 6, as the low thermal conductors exhibited the decreasing open porosity, the amount of fuels that soaked into the low thermal conductors decreased as well. In particular, when the open porosity of the low thermal conductors was 0.2% by volume or 1.5% by volume, the amount of soaked fuels decreased remarkably. It follows from these results that the low thermal conductor exhibiting an open porosity of 2% by volume or less can keep down the amount of soaked fuels especially.

Specifically, the low thermal conductor that is directed to the present piston according to Example No. 1 (or Test Sample No. 1) exhibited an open porosity of 0.2%, it is understood that it could suppress the amount of soaked fuels less as possible as the piston “A” did. Moreover, Test Sample Nos. 2, 4 and 6 that were likewise subjected to ultrasonic shot peening exhibited an open porosity of 1.5% by volume, 0.1% by volume and 1% by volume, respectively. Consequently, it is possible to see that pistons having the top into which Test Sample Nos. 2, 4 and 6 are incorporated can inhibit injected fuels from soaking into them effectively.

Having now fully described the present invention, it will be apparent to one of ordinary skill in the art that many changes and modifications can be made thereto without departing from the spirit or scope of the present invention as set forth herein including the appended claims.

What is claimed is:

1. A piston for internal combustion engine, the piston comprising:
a piston body having a top facing a combustion chamber of the internal combustion engine; and
a low thermal conductor being disposed in the top of the piston body;
the low thermal conductor having a superficial portion facing the combustion chamber, and an interior portion being disposed on a more inner side in the low thermal conductor than the superficial portion is;
the superficial portion exhibiting a first porosity;
the interior portion exhibiting a second porosity; and
the first porosity being smaller than the second porosity.

2. The piston according to claim 1, wherein the low thermal conductor comprises a sintered body.

3. The piston according to claim 1, wherein the superficial portion of the low thermal conductor has a combustion-chamber-side surface facing the combustion chamber, and the low thermal conductor further has open pores that open in the combustion-chamber-side surface and exhibit an open porosity of 2% by volume or less.

4. The piston according to claim 1, wherein the low thermal conductor exhibits as a whole a porosity falling in a range of from 3 to 30% by cross-sectional area.

5. The piston according to claim 1, wherein the superficial portion of the low thermal conductor exhibits the first porosity that is less than 10% by cross-sectional area.

6. The piston according to claim 1, wherein the interior portion of the low thermal conductor exhibits the second porosity that falls in a range of from 10 to 40% by cross-sectional area.

7. The piston according to claim 2, wherein the sintered body comprises an alloy that includes Fe and Mn.

8. A process for manufacturing piston for internal combustion engine, the piston comprising: a piston body having a top facing a combustion chamber of the internal combustion engine; and a low thermal conductor being disposed in the top of the piston body, and having a combustion-chamber-side surface to be disposed so as to face the combustion chamber;
the manufacturing process comprising a step of:
carrying out shot peening onto the combustion-chamber-side surface of the low thermal conductor.

9. The manufacturing process according to claim 8, wherein an open porosity, which open pores opening in the combustion-chamber-side surface of the low thermal conductor exhibit, is controlled to 2% by volume or less by means of the shot peening.

10. The manufacturing process according to claim 8, wherein the shot peening is carried out by means of ultrasonic shot peening.

11. The manufacturing process according to claim 10, wherein the ultrasonic shot peening comprises the steps of:
disposing the low thermal conductor on the top of the piston body;
enclosing an outer periphery of the combustion-chamber-side surface of the low thermal conductor with a housing; and
colliding steel balls with the combustion-chamber-side surface within the housing.
